(19) United States
(12) Patent Application Publication
(10) Pub. No.: US 2016/0065111 A1
(43) Pub. Date: Mar. 3, 2016

(54) VOICE COIL MOTOR DRIVING CIRCUIT

(71) Applicant: SAMSUNG ELECTRO-MECHANICS CO., LTD., Suwon-Si (KR)

(72) Inventor: Shin-Jae KANG, Suwon-Si (KR)

(21) Appl. No.: 14/609,263

(22) Filed: Jan. 29, 2015

(30) Foreign Application Priority Data
Aug. 28, 2014 (KR) 10-2014-0113185

(51) Int. Cl. H02P 25/02; H02P 7/288

(52) U.S. Cl. CPC H02P 25/028; H02P 7/288; H02P 2007/0083

(57) ABSTRACT

A VCM driving circuit in accord with one embodiment includes a driving block configured to generate a driving current of the VCM by receiving a reference voltage and a feedback voltage; a sensing transistor configured to generate the feedback voltage by sensing the driving current while in an on state thereof and to cut off the driving current while in an off state thereof; and a driving control block configured to control driving of the VCM through an on/off control of the sensing transistor.

### CROSS-REFERENCE TO RELATED APPLICATIONS

This application claims the benefit of Korean Patent Application No. 10-2014-0113185, filed with the Korean Intellectual Property Office on Aug. 28, 2014, the disclosure of which is incorporated herein by reference in its entirety.

### BACKGROUND

1. Technical Field

The present disclosure relates to a voice coil motor (VCM) driving circuit.

2. Background Art

Today's electronic devices, such as smartphones, are installed with a camera module having AF (auto focus) and OIS (optical image stabilization) functions in order to obtain high-quality images. Accordingly, technologies for low-noise linear motion of a voice coil motor (VCM) have become more important than ever, in order to realize the AF and OIS functions.

FIG. 1 illustrates an example of a conventional VCM driving circuit.

Referring to FIG. 1, the conventional VCM driving circuit comprises a DAC (Digital to Analog Converter) 10, a driving circuit 20 and a sensing resistor 30.

The DAC 10 receives a digital signal corresponding to a desired current value and generates and outputs an analog voltage signal corresponding to the received digital signal.

The driving circuit 20 includes an error amplifier 22 and a transistor 24. The error amplifier 22 receives a voltage of the analog voltage signal inputted by the DAC 10 and a feedback voltage generated by the sensing resistor 30, and allows a driving current (Ivcm) for driving a VCM to be generated by applying a voltage corresponding to a difference between the above two voltages to the transistor 24.

In the conventional technology described with reference to FIG. 1, the driving current (Ivcm) is supplied to a VCM coil 40 by use of a passive element (i.e., the sensing resistor 30) such as a general poly-resistor.

Generally, a driving current of 100 mA or more is required for driving the VCM, in which case the sensing resistor 30 needs to have a resistance value of between about 0.5 and 1 ohm.

However, it is difficult to realize such a small resistance value on an integrated chip (IC), and it is difficult to achieve stable performance because such a small resistance value is very sensitive to temperature and any processing deviation.

### SUMMARY

Embodiments of the present invention provide measures for obtaining linearity of a VCM driving current.

Moreover, embodiments of the present invention provide measures for an on/off control of a VCM and fine control of a VCM driving circuit.

### BRIEF DESCRIPTION OF DRAWINGS

FIG. 1 illustrates an example of a conventional VCM driving circuit.

FIG. 2 illustrates a VCM driving circuit in accordance with an embodiment of the present invention.

FIG. 3 illustrates a reference voltage generation block in accordance with an embodiment of the present invention.

FIG. 4 illustrates an equivalent circuit of the reference voltage generation block in accordance with an embodiment of the present invention.

FIG. 5 is a graph showing the linearity of a driving current generated in accordance with an embodiment of the present invention.

FIG. 6 illustrates a VCM driving circuit in accordance with another embodiment of the present invention.

FIG. 7 illustrates a VCM driving circuit in accordance with yet another embodiment of the present invention.

### DETAILED DESCRIPTION

In the description of the present invention, when describing a certain technology is determined to evade the point of the present invention, the pertinent detailed description will be omitted.

Hereinafter, certain embodiments of the present invention will be described with reference to the accompanying drawings.

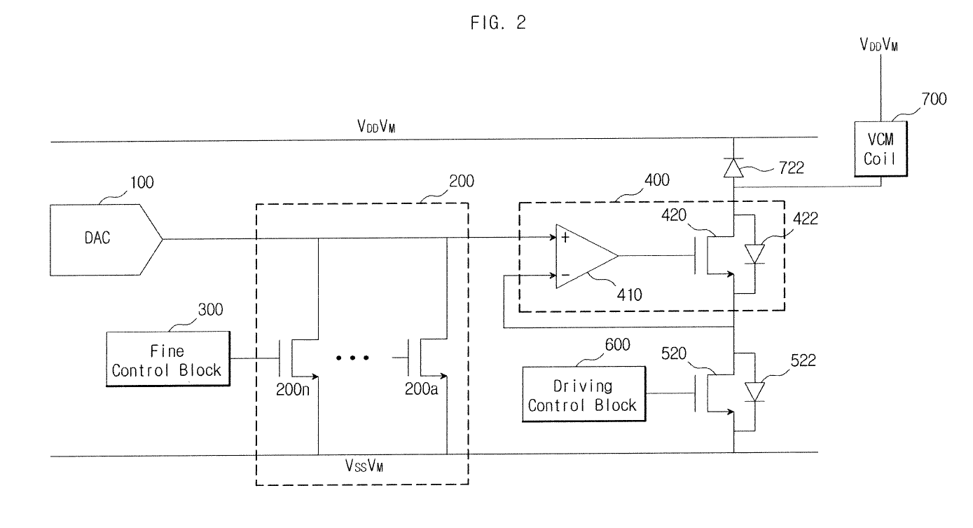

FIG. 2 illustrates a VCM driving circuit in accordance with an embodiment of the present invention.

Referring to FIG. 2, the VCM driving circuit includes a DAC (Digital to Analog Converter) 100, a reference voltage generation block 200, a fine control block 300, a driving block 400, a sensing transistor 520 and a driving control block 600. Depending on the embodiment, some of the above elements may be omitted.

The DAC 100 receives a digital signal for control of driving displacement of a VCM and converts the received digital signal to an analog signal. The converted analog signal, which is a current control signal for controlling a driving current flowing in a VCM coil 700, is outputted to the reference voltage generation block 200. In an embodiment, the DAC 100 may have resolution and dynamic range of between a few and a few tens of bits.

The reference voltage generation block 200 generates a voltage based on the current control signal inputted from the DAC 100 and outputs the generated voltage to the driving block 400. The voltage being outputted from the reference voltage generation block 200 is used as a reference voltage of an error amplifier 410.

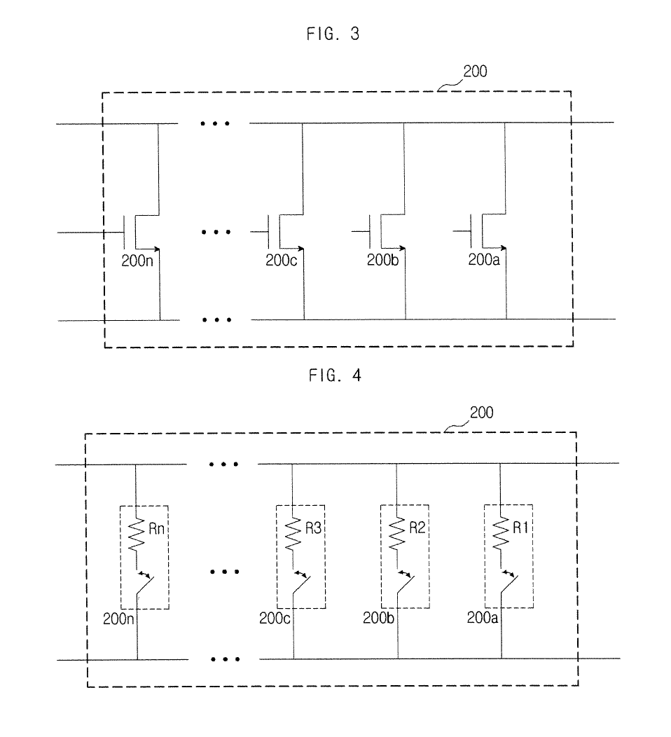

As shown in FIG. 3, the reference voltage generation block 200 may include a first to Nth transistor 200a . . . 200n (N being an integer of 2 or greater). The first to Nth transistor 200a . . . 200n may be turned on/off according to the current control signal inputted from the DAC 100. Moreover, the reference voltage generated by the reference voltage generation block 200 can vary according to the on/off statues of the first to Nth transistor 200a . . . 200n.

The first to Nth transistor 200a . . . 200n may each have a different channel-on resistance. For example, the first to Nth transistor 200a . . . 200n may each be an NMOSFET (N-channel Metal-Oxide Field-Effect Transistor) having a different channel width. The NMOSFET has a different resistance value in a saturation section based on a channel length and a channel width, and an active resistance may be realized through an on/off control of a gate.

FIG. 4 illustrates an equivalent circuit of the reference voltage generation block 200 shown in FIG. 3. Referring to FIG. 4, the transistors 200a . . . 200n included in the reference voltage generation block 200 form channel-on resistances R1 . . . Rn, respectively, according to the on/off status. A resistance value (R_{ref}) of the reference voltage generation block 200 may be expressed as Equation 1.

$$Rref = {( \frac{1}{Rn} + … + \frac{1}{R 3} + \frac{1}{R 2} + \frac{1}{R 1} )}^{- 1} \qquad Equation 1$$

Referring to FIG. 2 again, the fine control block 300 may adjust the overall resistance value of the reference voltage generation block 200 through the on/off control of the first to Nth transistor 200a . . . 200n included in the reference voltage generation block 200 and accordingly perform fine control of the driving current. For this, the fine control block 300 may generate an N bit control signal for on/off control of each of the first to Nth transistor 200a . . . 200n. The generated N bit control signal may be inputted to the gate of each of the first to Nth transistor 200a . . . 200n.

The fine control of the driving current (I_{DRV}) may be expressed as a relation among the current (I_{DAC}) of the current control signal outputted by the DAC 100, the reference voltage (R_{ref}) generated by the reference voltage generation block 200, and a channel-on resistance (Rₛₑₙₛₑ) of the sensing transistor, as shown in Equation 2.

$$\begin{matrix}{I}_{DRV} = \frac{Rref}{Rsense} {I}_{DAC} \\ = \frac{1}{Rsense ( \frac{1}{Rn} + … + \frac{1}{R 3} + \frac{1}{R 2} + \frac{1}{R 1} )} {I}_{DAC}\end{matrix} \qquad Equation 2$$

The driving block 400 may generate the driving current by having the reference voltage and the feedback voltage inputted thereto and include the error amplifier 410 and a driving transistor 420.

The error amplifier 410 generates a control voltage corresponding to a voltage difference between the reference voltage and the feedback voltage. Specifically, the error amplifier 410 generates the control voltage corresponding to a difference between the reference voltage inputted by the reference voltage generation block 200 and the feedback voltage generated by the sensing transistor 520 and outputs the generated control voltage to the driving transistor 420.

The driving transistor 420 is driven by the control voltage inputted by the error amplifier 410 and generates a driving current for driving the VCM. Specifically, the control voltage outputted by the error amplifier 410 is inputted to the gate of the driving transistor 420, and the driving current corresponding to the control voltage is generated by the driving transistor 420 and flows through the VCM coil 700.

The sensing transistor 520 is turned on/off by the driving control block 600 and performs different operations in the on/off state. For instance, the sensing transistor 520 may generate a voltage by sensing the driving current flowing through the VCM coil 700 when the sensing transistor 520 is in an on state, and the generated voltage may be inputted as a feedback voltage into the error amplifier 410. Moreover, the sensing transistor 520 may be turned off by the driving control block 600 to cut off the driving current flowing through the VCM coil 700. In an embodiment, the sensing transistor 520 may be an NMOSFET.

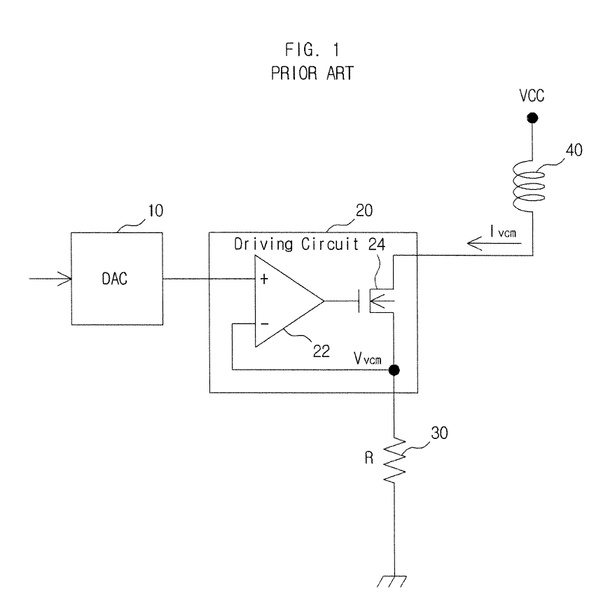

As described above, in embodiments of the present invention, the channel-on resistance of the sensing transistor 520 is used for sensing the driving current. As described with reference to FIG. 1, the sensing resistor needs to have a small resistance value of 1 ohm or less and a high current capability of 200 mA or more, and thus it is difficult to provide sufficient capability with a poly resistor or well resistor that is supported in general semiconductor processes. Even if a metal resistor were used, deterioration of matching with a transistor included in the reference voltage generation block 200 might occur.

Moreover, in the case where the sensing resistor is configured with a passive element such as a poly resistor, an additional switching element is required for the on/off control of the VCM. In such a case, the matching property of the switching element and the sensing resistor deteriorates, and linearity of the driving circuit is sacrificed due to processing and temperature deviations.

However, in embodiments of the present invention, the sensing resistor is formed with a channel-on resistor of a transistor, and thus an additional testing process, such as eFuse trim, is not required, and current sensing and VCM on/off control may be performed with one transistor. Accordingly, not only may the processing and temperature properties be improved, but the linearity of the driving current may be secured, and the circuit may be simplified and integrated.

A parasitic diode 422 component of the driving transistor 420, a parasitic diode 522 component of the sensing transistor 520, and a diode 722 absorb a current induced by a counter electromotive force generated by a VCM inductor component and protect the driving transistor 420 and the sensing transistor 520 from any external electric shock such as by static electricity.

The driving control block 600 performs on/off control of the sensing transistor 520, based on an inputted driving control signal. Specifically, the driving control block 600 performs on/off control of the sensing transistor 520 by applying a voltage to the gate of the sensing transistor 520 based on the inputted driving control signal.

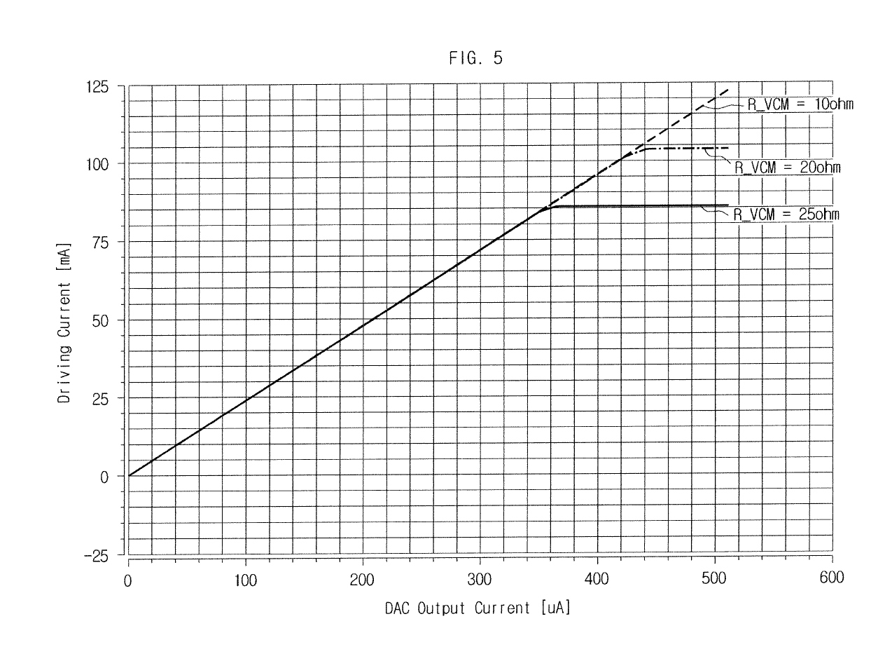

FIG. 5 is a graph showing the linearity of a driving current generated in accordance with an embodiment of the present invention.

Referring to FIG. 5, it can be seen that a VCM driving current has a linearity with respect to a DAC output current. Moreover, it can be seen that linearity is maintained regardless of the equivalent resistance (R_VCM) which the VCM coil has.

Hitherto, an embodiment encompassing both the circuit for driving control and the circuit for fine control has been described. Depending on the embodiment, the VCM driving circuit in accordance with embodiments of the present invention may perform any one of the driving control and the fine control. This will be described with reference to relevant drawings.

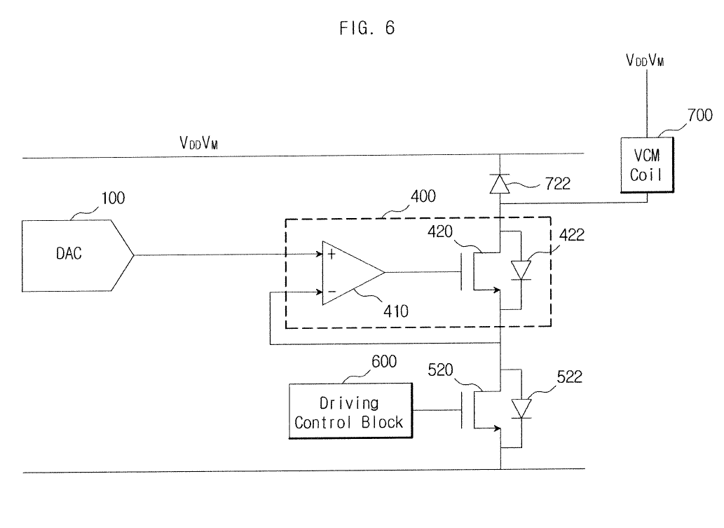

FIG. 6 illustrates a VCM driving circuit in accordance with another embodiment of the present invention.

Referring to FIG. 6, it can be seen that the reference voltage generation block 200 and the fine control block 300 described with reference to FIG. 2 are not included. Basic properties and operations of the elements shown in FIG. 6 are identical to those described with reference to FIG. 2 and thus will be omitted herein.

In the embodiment illustrated in FIG. 6, a current control signal outputted by a DAC 100 is inputted to an error amplifier 410, and a control voltage corresponding to a difference between a voltage value of the current control signal and a feedback voltage generated by a sensing transistor 520 is generated and inputted to a driving transistor 420.

A driving current is generated by the driving transistor 420 according to the control voltage, and the driving current is either sensed or cut off by the sensing transistor 520 by controlling the sensing transistor 520 to be turned on or off by a driving control block 600.

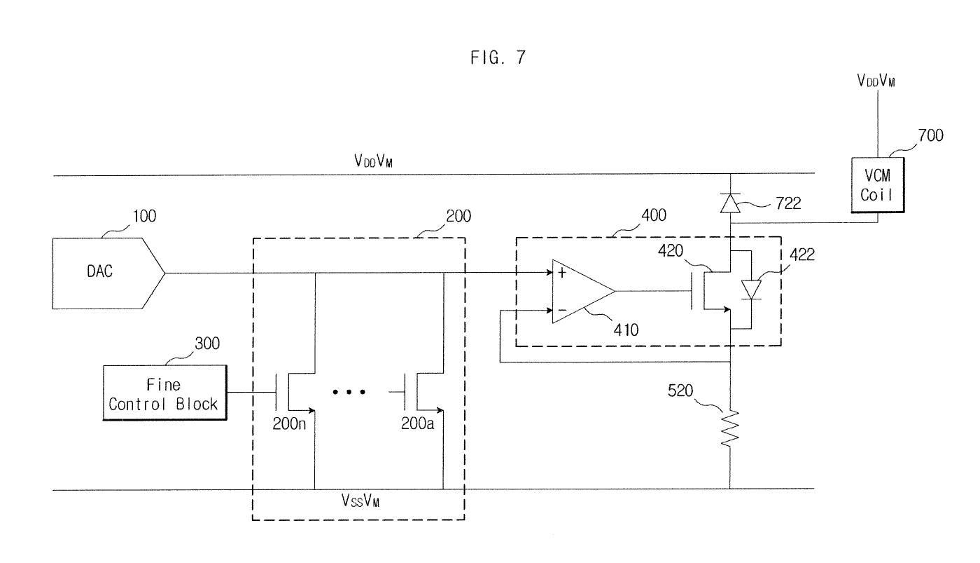

FIG. 7 illustrates a VCM driving circuit in accordance with yet another embodiment of the present invention.

Referring to FIG. 7, it can be seen that the driving control block 600 described with reference to FIG. 2 is not included and that a sensing resistor 520 is formed with a general poly resistor. Basic properties and operations of the elements shown in FIG. 7 are identical to those described with reference to FIG. 2 and thus will be omitted herein.

In the embodiment illustrated in FIG. 7, a reference voltage generated by a reference voltage generation block 200 and a feedback voltage generated by the sensing resistor 520 are inputted to an error amplifier 410, and a control voltage corresponding to a difference between the reference voltage and the feedback voltage is generated and inputted to a driving transistor 420. Accordingly, a driving current is generated by the driving transistor 420.

A fine control block 300 adjusts an overall resistance value of the reference voltage generation block 200 by controlling the on/off status of a first to Nth transistors 200a . . . 200n included in the reference voltage generation block 200. Accordingly, the reference voltage being inputted into the error amplifier 410 is varied, and as a result fine control of the driving current is performed.

The embodiments described hitherto are provided for easier understanding of the present invention and shall by no means be interpreted to restrict the present invention. The embodiments of the present invention may be modified and/or improved without departing from the technical ideas of the present invention.

For example, although it has been described hitherto that an NMOSFET is used as the sensing transistor and the transistors included in the reference voltage generation block, these transistors may be any transistor that is capable of forming an on resistance, for example, any one of PMOSFET (P-channel Metal-Oxide Field-Effect Transistor), BJT (Bipolar Junction Transistor) and IGBT (Insulated Gate Bipolar Transistor).

What is claimed is:

1. A voice coil motor (VCM) driving circuit configured for driving a VCM, comprising:
a driving block configured to generate a driving current of the VCM by receiving a reference voltage and a feedback voltage;
a sensing transistor configured to generate the feedback voltage by sensing the driving current while in an on state thereof and to cut off the driving current while in an off state thereof; and
a driving control block configured to control driving of the VCM through an on/off control of the sensing transistor.

2. The VCM driving circuit of claim 1, further comprising:
a reference voltage generation block comprising a first to Nth transistors, N being an integer of 2 or greater, and configured to receive a current control signal and generate the reference voltage varying according to an on/off status of each of the first to Nth transistors; and
a fine control block configured to perform an on/off control of the first to Nth transistors.

3. The VCM driving circuit of claim 2, wherein the fine control block is configured to generate an N-bit control signal for on/off control of each of the first to Nth transistors.

4. The VCM driving circuit of claim 2, wherein the first to Nth transistors have different channel-on resistances from one another.

5. The VCM driving circuit of claim 2, wherein the sensing transistor and the first to Nth transistors are an MOSFET (Metal Oxide Semiconductor Field Effect Transistor).

6. The VCM driving circuit of claim 2, further comprising a DAC (Digital to Analog Converter) configured to receive a digital signal for a driving speed control of the VCM and output the current control signal, which is an analog signal.

7. The VCM driving circuit of claim 1, wherein the driving block comprises:
an error amplifier configured to generate a control voltage corresponding to a difference between the reference voltage and the feedback voltage; and
a driving transistor configured to generate the driving current according to the control voltage.

8. A voice coil motor (VCM) driving circuit configured for driving a VCM, comprising:
a driving block configured to generate a driving current of the VCM by receiving a reference voltage and a feedback voltage;
a reference voltage generation block comprising a first to Nth transistors, N being an integer of 2 or greater, and configured to receive a current control signal and generate the reference voltage varying according to an on/off status of each of the first to Nth transistors; and
a fine control block configured to perform an on/off control of the first to Nth transistors.

9. The VCM driving circuit of claim 8, wherein the fine control block is configured to generate an N-bit control signal for on/off control of each of the first to Nth transistors.

10. The VCM driving circuit of claim 8, wherein the first to Nth transistors have different channel-on resistances from one another.

11. The VCM driving circuit of claim 8, further comprising a DAC (Digital to Analog Converter) configured to receive a digital signal for a driving speed control of the VCM and output the current control signal, which is an analog signal.

12. The VCM driving circuit of claim 8, wherein the driving block comprises:
an error amplifier configured to generate a control voltage corresponding to a difference between the reference voltage and the feedback voltage; and
a driving transistor configured to generate the driving current according to the control voltage.
